(19) United States
(12) Patent Application Publication
(10) Pub. No.: US 2024/0054159 A1
(43) Pub. Date: Feb. 15, 2024

(54) METHOD AND APPARATUS FOR A USER-ADAPTIVE AUDIOVISUAL EXPERIENCE

(71) Applicant: LMDP Co., Montreal (CA)

(72) Inventors: Charles Stéphane ROY, Montreal (CA); Philippe LAMBERT, Montreal (CA); Yann HAREL, Montreal (CA); Antoine Bellemare PÉPIN, Montreal (CA)

(21) Appl. No.: 18/233,546

(22) Filed: Aug. 14, 2023

Related U.S. Application Data
(60) Provisional application No. 63/397,644, filed on Aug. 12, 2022.

(51) Int. Cl. G06F 16/638; G06V 40/16

(52) U.S. Cl. CPC G06F 16/639; G06V 40/171; G06V 40/174

(57) ABSTRACT

A method and a system for providing an audio-video experience to a plurality of users. The method is executed by a processor coupled to a soundtrack database, a room speaker, and, for each user, a camera, a biometric sensor device and a headphone device. The method comprises: performing a base soundtrack of the audio-video experience for a first time period; analyzing a first set of data collected from the biometric sensor and the camera for each user of the plurality of users during a first reading window to determine a baseline state of biometric data, facial analysis data and head motion data; determining a first state of each user based on the biometric data; and generating and playing a personalized soundtrack for each user.

### RELATED APPLICATION

The present application claims priority to or benefit of U.S. provisional patent application No. 63/397,644, filed Aug. 12, 2022, which is incorporated herein by reference in its entirety.

### TECHNICAL FIELD

The present disclosure relates to methods and systems for audiovisual experience.

### BACKGROUND

Audience attending movie theaters is always looking for a new and improved experience. Movie makers, on the other hand, constantly improve quality of the picture and quality of the sound of the movies.

Each audience member has his or her personal preferences. In the comfort of their homes, the audience members may choose the movie they like. Moreover, they may control the volume, the brightness of the image, etc. If someone, around them, is not happy with the volume, the only solution is providing individual headphones. Such headphones may allow to control the volume of the sound while viewing the movie.

The purpose of watching the movie in a movie theater is usually to see the movie picture on a big screen in the company of other viewers. However, rarely all members of the audience of the movie theater have the same preferences and, more importantly, similar reactions to the same movie or even to the same episode.

### SUMMARY

According to one aspect of the disclosed technology, there is a method for providing an audio-video experience to a plurality of users. The method executed by a processor coupled to a soundtrack database, a room speaker, and, for each user, a camera and a headphone device and one or more biometric sensors, the method comprising: performing a base soundtrack of the audio-video experience for a first time period; analyzing a first set of data collected from the biometric sensor(s) and the camera for each user of the plurality of users during a first reading window to determine a baseline state of biometric data, facial analysis data and head motion data; determining a first state of each user based on the biometric data; for each user, in response to determining from the first state and at least one pre-determined state parameter of the user that the user needs to be pushed to a second state: based on a second base soundtrack for the audio-video experience for a second time period, the biometric data in the first state, and the facial analysis data and the head motion data during the first time period, generating a first customized soundtrack (which is also referred to herein as a “personalized soundtrack”) for the user, synchronizing the first personalized soundtrack with a video of the audio-video experience and a room soundtrack generated on the base soundtrack; and simultaneously and synchronously playing the first customized soundtrack on the headphone device during the second time period, the first room soundtrack on the room speakers and the video on a screen during the second time period.

Determining the first state of the user may be performed periodically at a pre-determined time interval during the audio-video experience. The method may further comprise adjusting the first room soundtrack based on a plurality of customized soundtracks comprising, for each user, the first customized soundtrack. The method may further comprise, at the end of the first period of time: analyzing data collected from the one or more biometric sensors and the camera for each user during the second period of time to determine the baseline state of biometric data, facial analysis data and head motion data; determining a third state of each user based on the biometric data, the third state having been achieved during second period of time; for each user, in response to determining from the third state and at least one pre-determined state parameter of the user that the user needs to be pushed to a fourth state: based on a second base soundtrack for the audio-video experience for a second time period, biometric data in the first state, and facial analysis data and head motion data during the second time period, generating a second personalized soundtrack for the user; synchronizing the second personalized soundtrack with and the video of the audio-video experience and the room soundtrack; and simultaneously and synchronously playing the second personalized soundtrack on the headphone device during a third time period. In at least one embodiment, the method may further comprise, at the end of the first period of time: analyzing data collected from the one or more biometric sensors and the camera for each user during the second period of time to determine the baseline state of biometric data, facial analysis data and head motion data; determining a third state of each user based on the biometric data, the third state having been achieved during second period of time; for each user, in response to determining from the third state and at least one pre-determined state parameter of the user that the user needs to be pushed to a fourth state: based on a second base soundtrack for the audio-video experience for a second time period, biometric data in the first state, and facial analysis data and head motion data during the second time period, generating a second personalized soundtrack for the user, generating a second room sound based on the second base soundtrack; synchronizing the second personalized soundtrack with and the video of the audio-video experience and the room soundtrack; and simultaneously and synchronously playing the second personalized soundtrack on the headphone device during a third time period, playing the second room soundtrack on the room speakers and the video on the screen during the second period of time. The audio-video experience may be a movie or other media content. The biometric data may comprise a heartbeat obtained from a photoplethysmogram (PPG), electrodermal activity (EDA) and brain activity obtained from an electroencephalogram (EEG), the biometric sensors being an EEG sensor, a PPG sensor and an EDA sensor and the camera.

The camera may perform video and infrared recording, measuring facial expressions of the respective user. The first time period and the second time period may have another time period in between them. The method may further comprise using a cognitive and emotional analysis. The cognitive and emotional analysis may comprise analyzing a degree of interactiveness and awareness of the user. The method may further comprise analyzing the first state of the user to choose the base soundtrack for the audio-video experience and to determine dynamic features for use to generate the first personalized soundtrack. The method may further comprise generating, for each user, an individual visual representation of the user's reaction to the audio-video experience and transmitting it to a user device.

In another aspect, there is provided a system for providing an audio-video experience to a plurality of users. The system comprises: a soundtrack database comprising a set of base soundtracks and a set of videos for the audio-video experience; a room speaker and a room screen for providing the set of videos, and, for each user, a camera and a headphone device, each headphone device having a biometric sensor configured to play a base soundtracks of the audio-video experience for a first time period and a personalized soundtrack for a second time period; and a processor coupled to a soundtrack database, the processor configured to: force the headphone device of each user to play a base soundtrack of the audio-video experience for a first time period; receive from the biometric sensor and the camera a first set of data for each user of the plurality of users during a first reading window and analyze, for the plurality of users, a plurality of the first set of biometric data, facial analysis data and head motion data to determine a baseline state of each user; based on the first set of biometric data, determine a first state of each user; for each user, in response to determining from the first state and at least one pre-determined state parameter of the user that the user needs to be pushed to a second state: based on a second base soundtrack for the audio-video experience for a second time period, the biometric data in the first state, and the facial analysis data and the head motion data during the first time period, generate a first personalized soundtrack for the user, synchronize the first personalized soundtrack with a video of the audio-video experience and a room soundtrack generated based on the base soundtrack; and force the headphone device of each user to simultaneously and synchronously play the first personalized soundtrack during the second time period, force room speakers play the first room soundtrack and visualize the video on a screen during the second period time period.

The biometric sensor may be at least one of an EEG sensor, a PPG sensor and an EDA sensor. The camera may perform video and infrared recording, measuring facial expressions of the user. The processor may be further configured to analyze the first state of the user to choose the base soundtrack for the audio-video experience and to determine dynamic features for use to generate the first personalized soundtrack. The processor may be further configured to, for each user, generate an individual visual representation of the user's reaction to the audio-video experience and transmit it to a user device for displaying on a screen of the user device.

According to at least one embodiment, the method is executed by a processor coupled to a soundtrack database, a room speaker, and, for each user, a camera, a headphone device and a biometric sensor device (such as, for example, one or more biometric sensors). In at least one embodiment, the method comprises: performing a base soundtrack of the audio-video experience for a first time period; analyzing a first set of data collected from the biometric sensor and the camera for each user of the plurality of users during a first reading window to determine a baseline state of biometric data, facial analysis data and head motion data; determining a first state of each user based on the biometric data; and generating and playing a personalized soundtrack for each user.

### BRIEF DESCRIPTION OF THE DRAWINGS

Further features and advantages of the present disclosure will become apparent from the following detailed description, taken in combination with the appended drawings, in which:

FIG. 1 is an illustration of a movie theater having technology as described herein;

FIG. 2 is an illustration of a visualization of the biometric data of the user provided on the user's device by the technology described herein;

FIG. 3 illustrates visualization of biometric data of the user registered during the projection of the movie, according to at least one embodiment of the present disclosure;

FIG. 4A illustrates an image generated and rendered to the user during the execution of the method as described herein, in accordance with at least one embodiment of the present disclosure;

FIG. 4B is a portion of FIG. 4A illustrating an image rendered to the user at the calibration stage, in accordance with at least one embodiment of the present disclosure;

FIG. 4C is a portion of FIG. 4A illustrating various streams, in accordance with at least one embodiment of the present disclosure;

FIG. 4D is a portion of FIG. 4A illustrating the characteristics modified by the sound effect filters (SFX);

FIG. 4E is a portion of FIG. 4A illustrating execution of the switching sound gates;

FIG. 5 schematically illustrates a method of generation of the soundtracks, personalized and for room speakers, in accordance with at least one embodiment of the present disclosure;

FIG. 6 illustrates the neurofeedback with the application to the electroencephalogram (EEG) recording as executed by the method and system as described herein, in accordance with at least one embodiment of the present disclosure;

FIG. 7 illustrates steps of the method of generation of the user-specific soundtrack, in accordance with at least one embodiment of the present disclosure;

FIG. 8 schematically illustrates steps of the method of generating the user-specific soundtrack, in accordance with at least one embodiment of the present disclosure;

FIG. 9 illustrates routines executed by a centralized server, in accordance with at least one embodiment of the present disclosure;

FIG. 10 schematically illustrates the execution of the signal processing and decision-making routine as a function of time, in accordance with at least one embodiment of the present disclosure;

FIG. 11 illustrates the execution of the personalized soundtrack generation routine, in accordance with at least one embodiment of the present disclosure;

FIG. 12 schematically illustrates the execution of the method, in accordance with at least one embodiment of the present disclosure;

FIG. 13A illustrates a non-limiting example of visualization of the preprocessed bio-physiological data of one user, in accordance with at least one embodiment of the present disclosure;

FIGS. 13B, 13C illustrate non-limiting examples of screenshots of presenting information to the user by the system of FIG. 1, in accordance with at least one embodiment of the present disclosure;

FIG. 14 illustrates a continuous real-time data processing pipeline, in accordance with at least one embodiment;

FIG. 15 illustrates a timeline of the adaptive soundtrack, in accordance with at least one embodiment; and

FIG. 16 illustrates the method for providing an audio-video experience to a plurality of users, in accordance with at least one embodiment of the present disclosure.

It will be noted that throughout the appended drawings, like features are identified by like reference numerals.

### DETAILED DESCRIPTION

The present description provides a system and a method for improving the experience of the audience members when consuming an audiovisual work. In other words, the present technology provides improvement of an audiovisual experience. The method and system as described herein may be used in a movie theater (cinema), in live concerts and shows, as well as during the presentation of virtual or online content. The improvement is based on a fact that each audience member can experience individual emotions and cognitive states related to the story and movie scenes. Various aspects of the present disclosure generally address one or more of the problems of adapting the soundtrack of the movie to an individual based on the individual reaction (such as, for example, emotions and cognitive states) that the audience member has experienced about the movie and the story.

It is an object of the present disclosure to provide a combination of an array of bio-physiological sensors (such as, for example, electroencephalogram (EEG), photoplethysmography (PPG), and camera-based emotion recognition) with a dual audio system that comprises both collective and individual sound diffusion, for the purpose of enhancing the theater experience by allowing the auditory material to adapt to the user's idiosyncratic reception of the piece. The system as described herein is agnostic and may process various types of data such as facial expressions obtained via an infrared camera, electrodermal response with the use of a smart bracelet, etc. By analyzing in real-time the biometric data collected from the user, informative of their emotional and cognitive reactions, the technology described herein makes the audio components (sound design, musical score) and their mixing qualities more “responsible” or “adaptive” in order to customize each experience by covertly attempting to manipulate the dynamic range of these reactions.

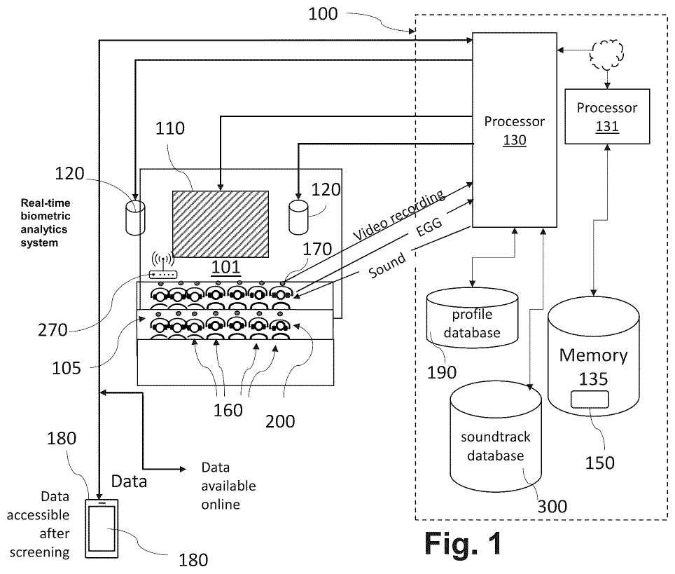

Referring now to FIG. 1, a movie theater room 101 (which is also referred to herein as a “movie theater 101” or “room 101”) is illustrated, in accordance with at least one embodiment of the present disclosure. The audience 105 of users 160 is located in front of a screen 110. The video of the video-audio work is displayed on the screen 110.

Room speakers 120 located in the room 101 are configured to provide an ambiance sound to the room 101. The ambiance sound may comprise, for example, base sound provided with the movie by the movie makers. In some embodiments, the ambiance sound may also comprise additional soundtracks that are added to the base sound.

The screen 110 and the room speakers 120 are connected to a processor 130. The processor 130 is connected to a memory 135. For example, the memory 135 may be a hard disk storing a base video-audio work 150 generated and provided by a movie maker. Such base video-audio work 150 comprises the base sound data for generating the base sound, and base video data for generating the base video. The base video is transmitted to the screen 110 from the processor 130 and is displayed on the screen 110. The memory 135 may have other base video-audio works, and may have a database with different identifiers of the base video-audio work 150.

Each user 160 (users are also referred to herein as “spectators” or “viewers”) located in the room 101 has a headphone device 200 (which may be a headphone, a pair of headphones, a pair of open headphones, open earphones which may be also called “bone conduction headphones”, etc.). The headphone device 200 is configured to receive, wirelessly or via a wire, a user-specific soundtrack and to play it to one ear or to both ears of the user 160. In at least one embodiment, the headphone device 200 has only one headphone speaker or more than one headphone speakers that may deliver sound to one ear of the user 160, such that the user 160 can hear the room sound delivered by the room speakers 120 with the other ear. In some embodiments, the headphone device 200 is configured to deliver both the user-specific soundtrack and the room sound simultaneously, for example, due to a design of the headphone device 200 which permits the room sound (also referred to herein as an “ambiance sound”, or “common sound” which is common to all users 160 as the common sound is broadcasted in the room 101) to be heard notwithstanding wearing the headphone device 200, and in addition to the personalized sound provided by the headphone device 200.

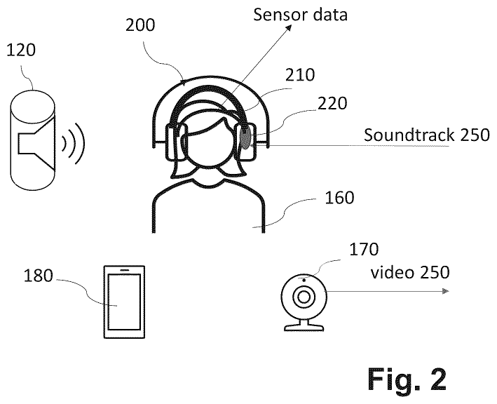

In at least one embodiment, each individual acquisition/diffusion system 200 is a combination of EEG sensors 210 and at least one headphone speaker 220, whether in a single device or on separate devices, as illustrated in FIG. 2.

Referring back to FIG. 1, in front of each user 160, a camera 170 is located. The camera 170 may be, for example, an infrared camera. The camera 170 films (performs video and/or infrared recording) a face of the user 160 in order to generate a video data providing information of the emotions of the user 160 expressed on the user's face.

The user 160 can also wear various combinations of biosensors to enrich cognitive and emotional measurements, including photoplethysmogram (PPG) (for example, to monitor user's heart rate), electrodermal activity (EDA) sensor (which estimates the sympathetic activity), and others.

The soundtrack provided to each user 160 (so-called “user-specific soundtrack 250” or “headphone audio” or “personalized sound” or “personalized soundtrack 250”) evolves because of and as a result of the user's biometric signals. The personalized soundtrack may be referred to also as a “customized soundtrack” because it may be similar for several users in some cases. The user's biometric signals also evolve because of the presentation through ongoing feedback. Such feedback is generated from the signals measured by the array of bio-physiological sensors. The feedback is also obtained from the video camera 170. Other devices, such as wrist-located device (for example, an electronic watch and/or electronic wrist band) with sensors may be used to collect various biometric data from the user. The technology as described herein uses biometric data, such as brain activity, facial expressions and cardiac activity.

In at least one embodiment, the headphone device 200 may be a Muse™ EEG headset by InteraXon headset. Such headphone device 200 allows the capture of physiological signals (at the entrance/input) and may be equipped with four electroencephalographic (EEG) biosensors that may measure cerebral activity (attention, commitment, mental workload).

At least one camera 170, such as, for example, night-vision infrared camera, that measures facial expressions (for example, 7 primary emotions) may be located discreetly and non-intrusively on a back of the row of seats, facing the spectators 160 of the next row. The camera 170 is configured to film the user 160 (also referred to herein as “spectator 160” or “viewer 160”).

The technology as described herein also uses the output from a cognitive and emotional analysis technology that is configured to determine the emotions and the engagement rates—i.e., the variation of the intensity of biosignals such as brainwaves, which is based on a technological architecture that employs a combination of biometrics, direct mapping and machine learning. The technology as described herein uses the acquisition and processing of bio-physiological data to extract emotional measures and real-time cognitive indices.

Instead of the base soundtrack generated by the movie makers, the headphone device 200 provides (plays) to the user 160 the user-specific soundtrack 250, which is modulated based on the user's biometric signals. Such modulation (variation) of the soundtrack makes each presentation of the video-audio work unique for each user depending on their current state of mind at the time of playing. As such, there may be several trillions of sound variations.

The technology as described herein is developed to generate both “adaptive” and “interactive” films which collect data emitted by bodily functions of the user's (viewers) 160 including their nervous system in order to evolve the narrative framework in real time. Such technology may be referred to as a part of a “neuro-cinema”. Preferably, the technology as described herein is referred to as a user-adaptive cinema (“adaptive movies”). Such a user-adaptive cinema is configured to adapt the experience to each user in the audience, in addition to adapting the experience to the audience in general.

The technology where a film (including audio components, video) is adapted to the whole audience may be referred to as an “audience-adaptive cinema”. The user-adaptive cinema provides, to each individual separately, the film (in other words, individually customized film) which is adaptive and, in some embodiments, augmented. When referred to herein, a cinematic work (film) may be “augmented” through hybrid broadcasting between fixed sound from the room's speakers, and dynamic sound through open headphones.

In at least one embodiment, the technology as described herein manages a content experience that is both adaptive (through the real-time conversion of participants' biometric data) and augmented (through hybrid broadcasting between fixed sound from the room's speakers, and dynamic sound through open headphones).

The technology as described herein analyzes the cerebral activity and other types of vital activity of the user's body, such as facial emotions, for example. The facial emotions may be captured by the video camera 170.

The technology as described herein is designed to generate new cinematic (cinematographic) works that are customizable. The soundtrack of the cinematic works, that is presented (played) to the user 160, becomes adaptive to emotional and cognitive responses of the user, which determines the customizable video-audio work.

In video games, music or sound environments permit one to adapt in real time to a situation. In some movies, when the strong emotions are simulated (for example, fear during a horror movie), the adaptive cinema as described herein may permit to covertly influence the engagement of the spectator (user of the technology) and to generate significant biometric variations.

In a conventional cinema, the sound effects and music dictate to the viewer the emotion conveyed by each scene of the movie. In the technology as described herein, it is the emotional and cognitive states (biometric data of these states) of the viewer that dictate the sound effects and musical score, which influences their emotional and cognitive state in return.

The technology as described herein may be used in cinema and extended reality experiences—so-called “XR”—with hybrid sound output (objective sounds of speakers/subjective sounds of headphones). In another example, the technology as described herein may be used in a home environment, such as, for example, video on demand (“VOD”), with a unique sound output (for example, instead of providing the user-specific sound in the headphones, the user-specific soundtrack may be provided to a room speaker).

To use the technology as described herein, the spectators put on a headset combined with biometric data measuring devices of the spectators, including, without limitation, EEG sensor(s), camera-based facial recognition module(s), PPG sensor(s), EDA sensor(s), and generate the user's emotional and cognitive data. For this, the processor 130 collects the data from the biometric data measuring devices (which may be also referred to as “bio-physiological acquisition devices” or “biometric sensor”) and processes the biometric data to feed a generative music engine. One biometric sensor device may have one or more biometric sensors as described herein.

For example, the biometric sensor 210 (or the biometric sensor device 210) may be located on (or attached to) the headphone device 200. Alternatively, the biometric sensor 210 (or the biometric sensor device 210), may be a separate device or a set of devices, which is configured to capture the biometric data in order to transmit the biometric data to the processor 130. The biometric data may comprise a heartbeat obtained from a photoplethysmogram (PPG), electrodermal activity (EDA) and/or brain activity obtained from an electroencephalogram (EEG). The biometric sensor 210 may be an EEG sensor, a PPG sensor and/or an EDA sensor. In at least one embodiment, the biometric sensor 210 (or the biometric sensor device 210) may comprise an EEG sensor, a PPG sensor and/or an EDA sensor, and, in some embodiments, a camera.

The processor 130 generates individual visual representation of the user's journey (user's reaction to the audio-video experience) for each user in the room 101. In some embodiments, the processor 130 may transmit the generated individual visual representations to the user devices 180.

The user device 180 may be a smartphone, a laptop, a tablet computer, etc.—an electronic device that has an input device (for example, a touchscreen) and a visual output device (for example, the screen or the touchscreen). Such user device 180 has a user device processor configured to receive data and to display the data on the output device such as the user device screen. The user may provide input (for example, select among options) through the user device 180. This may be done using (navigating) a dashboard displayed on the touchscreen of the user device 180 for reporting the experience. In some embodiments, the data collected by the user device 180 may be transmitted to the main processor 130.

The data aggregation module 270 may comprise, in addition to the processor 130 and sound-generating processor 131, the databases as described herein. When referred to herein, the system 100 comprises the processor 130, the sound-generating processor 131, memory 135, soundscapes database 300, database 190. The system 100 may be implemented as a data aggregation module 270 which is configured to communicate (for example, wirelessly) with the cameras 170 and headphone devices 200 of the users in the room 101. Alternatively, the sound-generating processor 131 may be located remotely from the processor 130, and the memory 135 and soundscapes database 300 may be also located remotely from the data aggregation module 270 and the room 101.

In some embodiments, the data aggregation module 270 which is located in the room 101 is configured to only receive the data from various devices (camera, headphone device 200, etc.) as described herein, and then transmit such data (wirelessly or via a wired link) to the processor 130 that is located remotely, and while the user-specific soundtrack is being generated, to transmit the generated soundtrack to the headphone devices 200. In addition, in some embodiments, the data aggregation module 270 is also configured to transmit ambiance sound to the room speakers 120. In addition, in some embodiments, the data aggregation module 270 is configured to transmit the video to the screen 110. According to an embodiment, all the transmission is provided by the data aggregation module 270 to ensure synchronization of the video and audio performance.

In at least one embodiment, after a few minutes during which the room audio (emitted from the room speakers 120) and headphone audio (delivered to and emitted from the headphone devices 200) are similar, the processor 130 collects, from the biometric sensors 210 of the headphone device 200, the biometric data of spectators 160 in real time.

The processor 130 then generates the emotional and cognitive journey of the user 160 in real-time. In other words, the processor 130 generates, in real time, a visual representation of the user's reaction to the soundscape. Gradually, the headphone audio, presented in the headphone device 200, becomes personalized in real-time to respond accurately to emotions experienced by each user 160 by dissociating themselves from audio of the room (mostly noises) at the times on a sensory basis (the intimacy of the sound of the headphones in the hollow of the ear) and physical (the sound vibrations of the low frequencies of the room), thus accentuating additional experience.

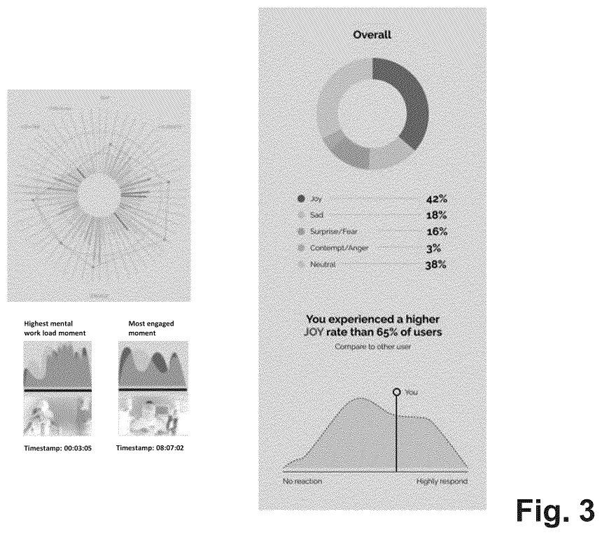

To provide information on individual emotional journey of each user 160, the system 100 as described herein exports the data of the users 160 and the system 100 presents the data securely online as a visual statistic, both individual and group-related, as illustrated in FIG. 3. In other words, the system 100 presents the generated visual representation of the user's reaction to the soundscape on the user device or on a server.

FIG. 3 illustrates visualization (visual representation) of user's biometric data registered during the projection of the movie. The image (visualization of the biometric data) generated by the processor 130 provides the information regarding how the movie that has been seen by the users 160 has affected the users 160. It is possible to identify scenes that have mostly impacted the users 160 and each user 160 may compare results with the average for the other users.

Adaptive cinema technology is configured to teach a sound production system to recognize different types of biometric signals generated by spectators in order to generate, in real time, sound and melodic variations that personalize the user's viewing experience (such as, for example, by accentuating effects related to feelings of disgust, anger, of desire, fear, etc.—the emotions aroused when watching, for example, a horror movie).

The technology as described herein is configured to: associate biometric information (flows) with emotions and cognitive states; associate the emotional and cognitive states with soundscapes and musical motifs denoting macro and microvariations in their dynamics, tone, texture and intensity; establish strong and meaningful associations between these atmospheres and motifs with the narrative of each scene; synchronize sound effects and musical patterns with images in real time; broadcast adaptive sound effects and music soundtrack in real time to a multi-user audience.

Aggregation of Biophysiological Data

First, the system 100 uses raw data to generate emotional and cognitive indices. Vital signals measured by the headset (EEG sensor and/or a cardiac activity sensor) and infrared camera (to detect and record facial emotions of the user) are collected by the processor 130.

First data collected is used to determine initial data (which may also be referred to as a “baseline”) with which the eventual fluctuations of intensity of the biometric signal are compared. For example, if the signal is more intense than the baseline, one soundtrack “A” may be generated and broadcasted in the headphones of the participant, and, if the signal is less intense than the baseline, another audio stream “B” may be generated and broadcasted in the headphones.

The processor 130 may be a part of a data aggregation module 270, illustrated in FIG. 1. The data aggregation module 270 may also have an antenna, the memory 135 and a database 190.

When generating the emotional and cognitive indices, the processor may use machine learning and is based on the data collected from a plurality of users (for example, thousands of users) to identify biological informative signals based on the state of the person. Movements due to distraction or sneezing, for example, are eliminated from data collection, hence the importance of cleaning up and interpreting this raw data, to produce meaningful clues for analytical algorithms. This step may be performed by a third-party biometric analysis module or by an internal biometric analysis module. Once the raw data has been sorted, the processor associates these relevant vital signals with:
(a) 7 emotions, such as, for example: joy, sadness, fear and anger, surprise, disgust and contempt and
(b) 2 clues to cognitive functioning commonly used in neuromarketing: engagement and mental workload.

In at least one embodiment, the abovementioned association of the relevant vital signal is not used in the first iteration of the experience.

The processor 130 thus generates emotional and cognitive indices and generates a visual representation of the emotional and cognitive indices. Such visual representation of the emotional and cognitive indices thus maps person's emotions and his/her attentional state in real time. Such a map of emotions and cognitive indices identifies, in real-time, the exact moments during which the user (subject) is, for example, afraid, the exact moments where the user's engagement seems to be decreasing, and when the euphoria manifests. Various emotions may be mapped in a similar manner. At the cognitive level, EEG signals (as well as data from the biometric sensor 210 in general) may be used to measure mainly the level of attention or commitment, as well as the mental workload.

The system 100 then uses the data obtained with the emotional and cognitive indices to generate a personalized sound environment. Information about the emotional and cognitive indices is continuously generated and updated by the processor 130. For example, such information may be stored in a temporary memory—to be used by the processor 130 to perform further steps as described herein. The information about the emotional and cognitive indices may be also stored in a profile database 190. For example, the information about the emotional and cognitive indices may be stored for as long as the user 160 participates in the experiment or performance of the audio-video experience, and/or for further use for generating soundtracks for other users 160 later.

The processor 130 and the system 100 as described herein performs a) conversion of biometric signals into audio streams b) intelligently (sounds evoke fluctuations in the cognitive and emotional states of the viewer) c) in real time d) in synchronization with the image e) in a multi-user broadcast environment.

The technology permits to transform the emotional and cognitive indices into a soundtrack that sublimates the emotions already felt by the user 160. The technology transcribes the psychological journey of the user 160 into a sound/musical language. The system 100 as described herein operates in real time, and that is, in perfect synchronization with the image tape. Such transcription of the psychological journey to the sound may be performed by the processor 130—the same processor that collected the biosensor data from the biometric sensor 210 and the video from the camera 170. Alternatively, and preferably, the generation of the sound may be performed by another processor—sound-generating processor 131. In some embodiments, the sound-generating processor 131 may be part of the processor 130. The system generates sound/music and synchronizes with the video based on the user's psychological journey.

If the players' decisions (for example, gameplay history) and screen format constitute the respective variables of adaptivity (and, in some embodiments, interactivity) in video games, the emotional and cognitive responses of participants who watch the video to determine the type of experience that the user 160 may experience. The technology as described herein adapts the principle of adaptive soundtrack to cinema to develop a whole new narrative grammar for a specific movie and/or movie genre. For example, cinema may comprise linear entertainment content such as movies, digital series, live performances and extended reality (XR) experiences.

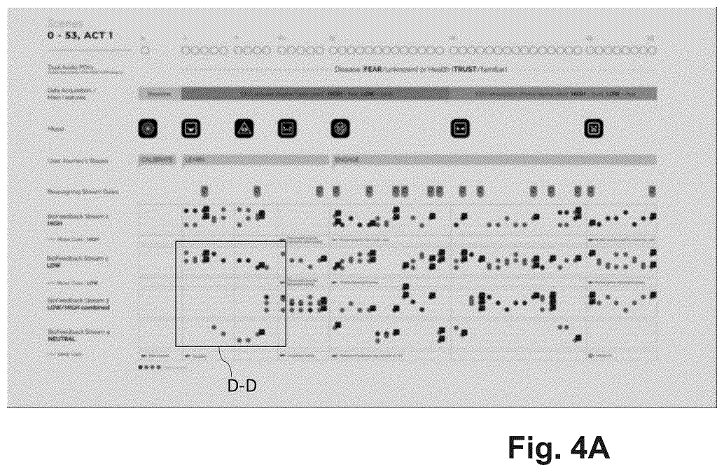

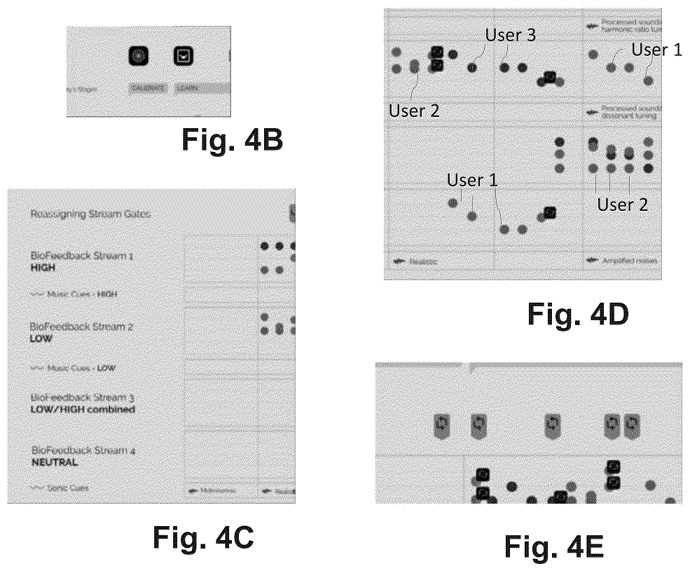

For example, a bioadaptative horror experience (Bio-feedback horror) may be generated by the processor. For example, the movies of the horror film genre usually cause strong emotions. The technology as described herein allows to maintain the engagement of the viewer (user 160) at a high level and thus generate large biometric variations. The image generated by the processor based on the user's emotions is illustrated in FIG. 4A.

Calibration

At a step of calibration, first, the data processor 131 receives the data with the emotional and cognitive indices (for example, from the main processor 130) and calibrates it. The data processor 131 determines for each user a basic level of the emotions, in relation to which their emotional and cognitive variations are later compared. The user 160 is therefore considered as having a high-level engagement when their engagement score is higher than their basic level of engagement. This state then determines which audio stream may be assigned to it. An example of the image rendered to the user 160 at the calibration stage is illustrated in FIG. 4B.

Streams

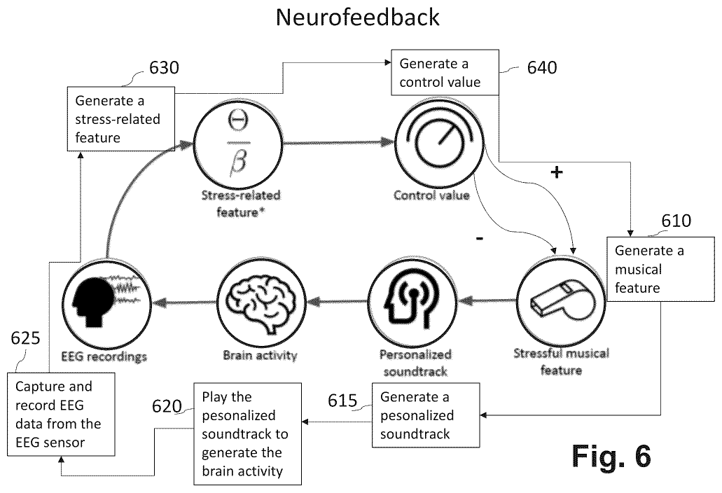

Streams are audio tracks that refer to a particular emotional atmosphere. According to an exemplary and non-limiting version developed during the prototyping phase, three types of flow associated with emotions were conceptualized: Blissful, Mysterious, Stressful. This is an example, as other categories can be defined, where the streams can be categorized according to specific needs. In addition, a fourth neutral flow, or without any particular atmosphere to the whole, was added. These flows are quite distinct so that the viewers (participants) may quickly distinguish them auditorily and aim to suggest different interpretations for each of the scenes. Thus, the technology as described herein may permit to establish coherent links between the mental state of the participant and the interpretation that may be suggested by the flow associated with it. For example, if the decision-making processor 130 determines that the subject is stressed and their cognitive workload is high, it may be assigned the audio stream “Stress”. This ‘mapping’ between the mental state and the soundtrack may have the effect of reinforcing (FIG. 6.) the subjective experience of the user 160 and direct the user 160 towards varied but consequent narrative readings. (The terms user 160, spectator, viewer—are used herein interchangeably and, unless specified otherwise, refer to a person wearing the headphone device while viewing the movie in the movie theater.) The various streams are illustrated in FIG. 4C.

Additional Filters

In addition to sound streams, sound-generating processor 131 adds, to the base sound, sound effects filters (SFX) (applied to the base sound to modify it) that use indicators of emotional and cognitive state and modulate the soundtrack in real time. These filters help to ensure that two users in the same stream do not hear the same soundtrack. These SFX filters modify various characteristics of the base sound. The characteristics modified by the SFX may comprise: dynamics (such as, for example, amplification, attenuation, compression, muting), temporality (such as, for example, delay, reverberation, distortion, echo, phasing, crossover) and positive/negative binary oppositions (such as, for example, harmonious/dissonant, major/minor, organic/synthetic, etc.) sound to give it an even more pronounced emotional color (FIG. 4D).

In FIG. 4D, which is an enlarged portion along the lines D-D of FIG. 4A, each dot corresponds to a data related to one user (user 1, user 2, user 3, etc.), and each dot for the same viewer on the timeline represents the sound variations (variations in the personalized soundtracks generated by the system and provided to the user 160) testifying to the fluctuations of the participants' biometric data (biodata) received from the biometric sensor 210.

Switching Sound Gates

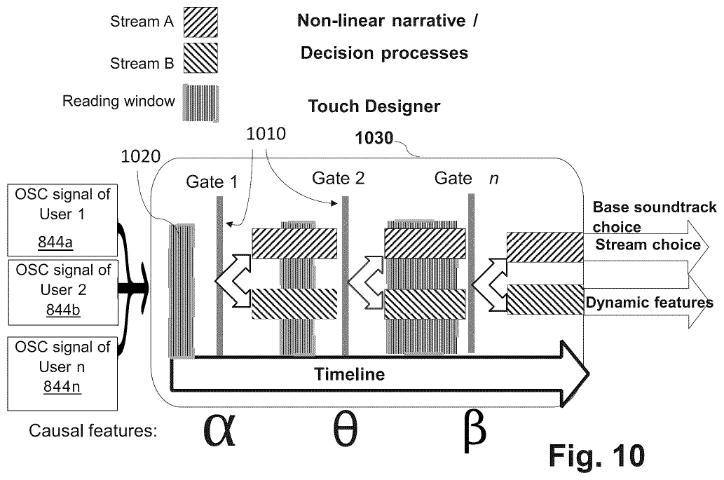

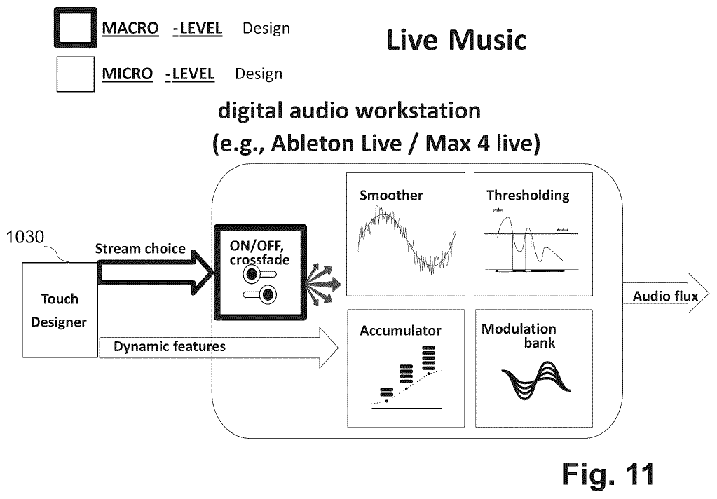

As our emotions evolve from one scene to another in most traditional films, the users 160 are not assigned the same stream. When the film (the term film is used interchangeably with the term “movie”) progresses and as the narrative and staging increase in intensity, the viewer 160 is able to maintain or swap sound flows according to the evolution of the user's emotional and cognitive state. A portion of FIG. 4A illustrating the switching sound gates is provided in FIG. 4E. The switching sound gates are also illustrated schematically in FIG. 10.

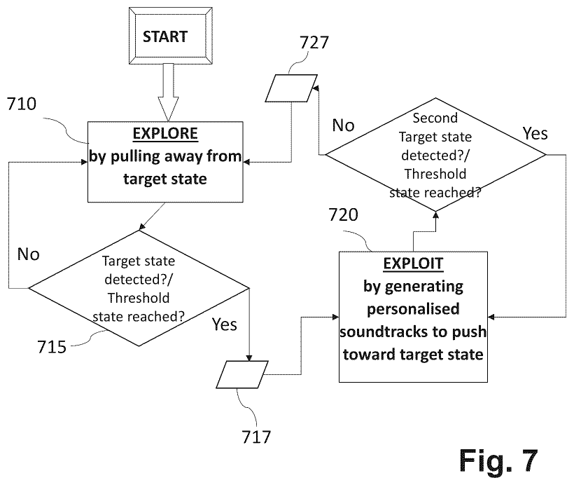

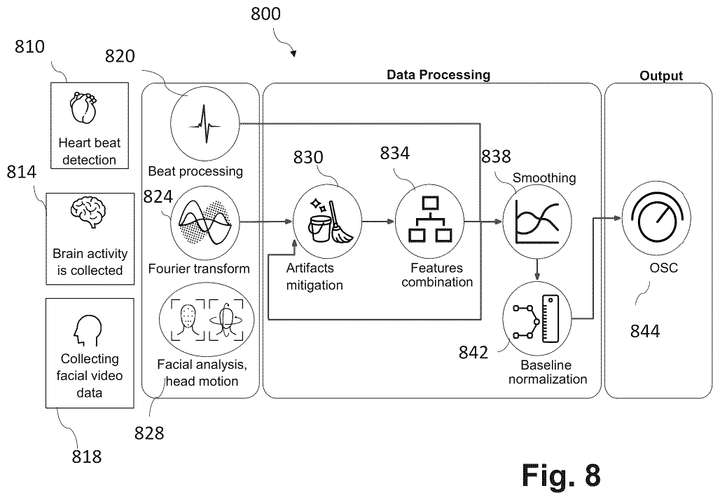

At any given switching sound gate 1010, in order to determine whether to accentuate a cognitive state or to push the user towards the opposite state, a foraging model based on an exploration/exploitation trade-off is deployed by the decision-making processor (FIG. 7). At the start of the experience, all subjects (viewers 160) are said to be in the Explore mode of feedback 710, in which the emotional and cognitive indices related to the target state are negatively mapped to the musical features inducing that state. For example, a user showing low levels of stress during a stressful scene may have their “stress-related” indices mapped to relaxing features, thus promoting the exploration of their emotional and cognitive landscape.

Still referring to FIG. 7, when a state determined as being the target state (such as designed by the artists) is detected strongly enough, the decision-making processor 131 then toggles the Exploit mode 720, in which the target-state related musical features are positively mapped to the emotional and cognitive features. This second mode of feedback is expected to promote the target state by increasing musical features related to that state whenever the associated emotional and cognitive indices increase, thus establishing a positive feedback loop. For example, a user in the Exploit mode in whom a strong level of stress (target state) is measured may hear stressful musical features increase as their stress level increases. When this manipulation fails to effectively increase the target state, the user is sent back in Explore mode 710 until another target state is detected. In other terms, when the user 160 is determined to be in the Explore mode, the system pulls the user 160 away from the target state, and when the user 160 is determined to be in the Exploit mode, the sound-generating processor 131 is configured to generate the personalized soundtrack to push the user toward the target state.

In total, there may be between 5 and up to 30-60 switching sound gates during one film. The number of the reading windows (which may also be referred to as “referral windows”) may vary even more, depending on the duration and type of the film (content). At the switching sound gates 1010, the system 100 reassigns different emotional soundscapes to the user 160 and better adapts to the user's feelings and emotions in real time. The steps for the execution of these re-assignments are determined by evaluating the distance between the viewer's state/status during the calibration and the viewer's status determined during the last switching sound gate.

For the multi-user version intended for rooms and digital distribution, the number of switching sound gates as well as the type of micro-variations may be increased (for example, multiplied) by setting certain emotional objectives for scenes and acts. This may be done in order to accentuate moments of calm or progressive voltage throughout the experience.

For example, for 30 switching sound gates 1010 used to navigate between four different streams (4³⁰), there may be several trillion sound variations, each customized through the use of additional filters.

Providing the audio-video experience as described herein aims to initiate a new type of dialogue between musical creation, new technologies, neuroscience, and cinema. By including real-time and customized bio-feedback and generative music in the film creation process, the technology as described herein unveils new creative avenues and brings its share of challenges to its technical and artistic teams.

For example, musical composers and sound designers may record a number of different and distinct soundscapes associated with emotions that may be deployed dynamically during the movie to provide a personalized experience for each viewer 160. The soundscapes database 300 may thus be developed. For example, the soundscapes may be movie-specific and/or movie genre-specific. The soundscapes located in the soundscapes database 300 (also referred to herein as a “soundtrack database 300”) are developed to help coherently link the bio-physiological states of the person/user 160 with the emotion suggested by the music. In order to achieve such a link, one needs to:
Develop several versions of the same soundtrack for a movie, all consistent with each other to allow the smooth passage from one to the other,
Design algorithmic parameters determining the activation and calibration of the number of dynamic and temporal filters according to positive/negative oppositions as described above;
Consider both the dramatic issues of the narrative and the genre of the movie in which music traditionally plays an important role (such as, for example, announcing a threat, intensifying a sense of urgency);
Orient the point of view of a scene using the sound—external point of view vs. point of view of the main character taking into account the objective soundtrack shared with other spectators through the speakers of the room; and
Take into account multiple (e.g., trillions) of possible sound combinations to propose routes that evolve from emotional and cognitive response of the viewer.

Table 1 provides examples of cutting of sound variations.

TABLE 1

| | ACT 1 | ACT 2 | ACT 3 |
|---|---|---|---|
| ACTION | Claustrophobic | Escape | Childbirth and release |
| | group closed | outside of | from forest refuge |
| | session at an | the city | |
| | institute | | |
| SOUND TONE | Sustained | This section | The music in this |
| AND MUSICAL | simple sound | is more | section is generated |
| | frequencies | melodic, | using a variety of |
| | gradually | using fast- | techniques associated |
| | evolving and | repeating | with concrete |
| | gaining in | synthetic | music - for example, |
| | intensity | sequences | an assembly of |
| | | | natural sounds |
| | | | often electronically |
| | | | modified and |
| | | | presented as a |
| | | | musical composition. |
| TREATMENT | Harmonious | Exalted | External point of |
| OF SIGNAL | with pure | atmosphere | view of the scene, |
| (stream A): | luminous tones | of liberation | mainly the voice |
| EEG metric | suggesting a | and infinity | and breath for |
| above | more positive | | amplify the primitive |
| threshold. | and lighter | | physicality of |
| | vibration of | | childbirth scenes |
| | the scenes | | |
| TREATMENT | Cold, dense | Feelings of | Internal point of |
| OF SIGNAL | and synthetic | fear and | view of the main |
| (stream B) | adding a more | anxiety with | character, cutting |
| EEG metric | dissonant and | a greater | and filtering |
| below | mysterious | emphasis on | everything on the |
| threshold. | anxiety- | stubborn | outside, giving a |
| | provoking tone | repetition | unique insight |
| | to the scenes | and rhythm | into the main |
| | | | character's inner |
| | | | biological and |
| | | | emotional reality |
| TREATMENT | | | |
| OF SIGNAL | | | |
| (stream Virus) | | | |
| Realtime | | | |
| modulations | | | |
| using between | | | |
| 2 and 4 EEG | | | |
| metrics. | | | |

The technology as described herein is configured to generate and deliver a highly engaging and personalized adaptive soundtrack for each participant without requiring complex equipment or intrusive interface.

The technology as described herein uses a bio-feedback loop. It is designed with the aim of allowing development and implementation in place of adaptive soundtracks reacting to variations in physiological states. The instructions executed by the decision-making processor 130 therefore make it possible to bridge emerging neuromarketing technologies (EEG, machine learning, computer vision) and the audiovisual post-production pipeline. It is a so-called “passive” neurofeedback, which comprises transmitting to the user of the sensory indicators (such as the sound) of the user's internal states (emotional and attentional) in order to forge a coherent cinematographic experience of its own. By executing calibration, audio generation and synchronization of the different tracks, the method and the system allows to script in a dynamic, scalable and engaging way a personalized soundtrack.

In addition to the dynamic sound streams (personalized sound) generated and transmitted (diffused) to the user's (participant's) ears through the headphone device 120, the system generates a room sound (room ambience sound) in order to broadcast a neutral flow (the same for all spectators). The room sound is produced by the room speakers 120, is expected to be linear (no bifurcations of the audio stream), and generates emotions and physical sensations more immersive and engaging, while allowing the viewer 160 to distinguish the fixed audio frame from the elements of the adaptive sounds (personalized soundtrack) in a physical and sensory way.

The technology uses EEG signals and other biometric data to generate sound effects and musical motifs in real time and in synchronicity with a linear image editing. The processor 131 is configured to synchronize collection of the data and generation of the soundtracks for a multi-user audience in real time.

In at least one embodiment, the sound scripts may be generated according to the feedback received from the participants and based on their physiological state of the user.

The cognitive states are monitored and covertly induced by neurofeedback. The technology uses variability of the brain states. The technology permits to maximize the diversity of experiences (intra- and inter-individual) using non-linear narrative (music streams) and generate music based on bio signals received as biometric data.

To implement the technology, each one of the various musical streams (soundtracks) need to be distinguishable. The system 100 as described herein determines how to generate the soundtracks and then generates the soundtracks based on bio signals received as biometric data which may be coherently connected to each other to form coherent music flow, using the real-time modulation of the sound.

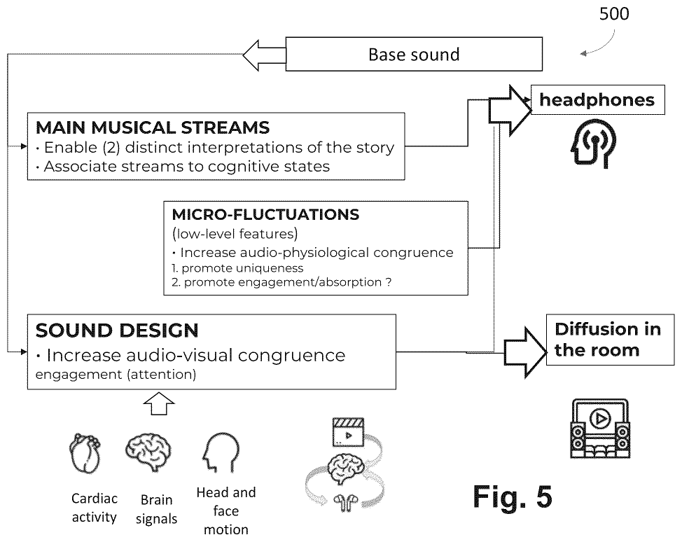

FIG. 5 schematically illustrates the method 500 of generation of the sound for the headphone devices 200 and the room speakers 120, in accordance with at least one embodiment of the present disclosure. The technology permits to enhance the cinematic experience by revealing and affecting the user's inner states in a feedback loop.

FIG. 6 illustrates the neurofeedback with the application to the EEG recording as executed by the method and system as described herein, in accordance with at least one embodiment of the present disclosure. At step 610, a musical feature is generated. For example, the musical feature may introduce stress, and may be, for example, a whistle sound. At step 615, a personalized soundtrack, which has, in addition to a general soundtrack (that would be presented to all users), the whistle sound. At step 620, the personalized soundtrack is presented to the user, by transmitting it to the headphone speaker 220 and playing it to the user 160. The EEG sensor 210, at step 625 receives and records the EEG data from the EEG sensor 210. At step 630, a stress-related feature is generated. In at least one embodiment, the stress-related feature depends on Θ (approximately 4 Hz to 7 Hz) and R (approximately 13 Hz to 30 Hz) brain signals (brain wave signals). Based on the stress-related feature determined at step 630, at step 640, a control value is generated, which modifies (or affects the generation of) the stressful musical feature that can be used later to generate the personalized soundtrack at step 615.

FIG. 7 illustrates the method of generation of the user-specific soundtrack 250, in accordance with at least one embodiment. Following the start, the system 100 explores the state of the user 160 by executing the explore routine 710 and re-iterating the generation of the user-specific soundtracks 250 until the target state 717 is detected at step 715. For example, the target state 717 may correspond to a certain level of scariness—for example, qualified by specific pre-defined heartbeat or other bio-signals collected by a sensor, such as EEG sensor 210. The EEG threshold of the EEG metric corresponds to a normalized value (baseline corrected) associated with a specific brain signal feature. The EEG threshold is determined based on previous data collection and set to optimize the variability in the narrative branching process. The guidelines for generation of music may comprise, if within the “explore” cycle, to pull away from the first target state 717, and, if within the “exploit” cycle, to push toward the second target state 727.

When the first target state 717 has been reached and detected by the system 100, the system 100 may generate the soundtracks with a goal to push the user toward a second target state 727. For example, the system may try, at the second target state 727 to increase the heartbeat of the user 160 and/or other indicator of, for example, scare emotions expressed by the user 160. Thus, the system executes the exploit routine 720. When the second target state is undetected again, the system explores again with a newly generated soundtrack to try to pull the user 160 away from the first target state—in other words, to receive the biosensor data that confirms that the user 160 has been pulled away from the first target state to achieve the second target state.

FIG. 8 schematically illustrates the steps of the method 800 of generating the user-specific soundtrack 250, in accordance with at least one embodiment of the present disclosure.

First, heartbeat is detected and collected at step 810, the brain activity data is collected at step 815, and the facial video data is collected at step 820. The system 100 (for example, the processor 130) then uses Fourier transform to process the brain activity data at step 824 and uses facial analysis and head motion detection techniques to process, at step 828, the data obtained with the camera 170 (for example, the infra-red camera).

After the artifact mitigation at step 830, and features combination at step 834, the data is smoothed at step 838, and then baseline normalization is performed at step 842. At the output, at step 844, the open sound control (OSC) signal is generated. OSC is a protocol for networking sound synthesizers, computers, and other multimedia devices for purposes such as musical performance or show control. OSC's advantages include interoperability, accuracy, flexibility and enhanced organization and documentation.

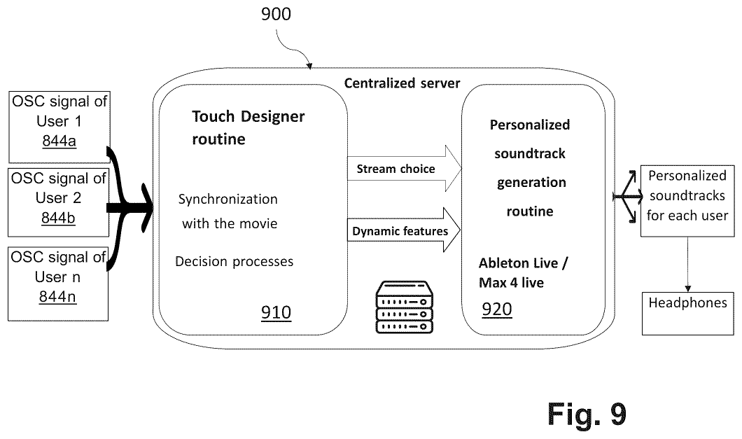

Referring now to FIG. 9, the OSC signals 844a, 844b . . . 844n, each OSC signal having been generated for one user 160 is then transmitted to a centralized server 900 (which may comprise the sound-generating processor 131 described above with reference to FIG. 1). First, the OSC signal(s) 844 is(are) used by the decision-making routine 910 (executed, based on the instructions stored in the server 900). The decision-making routine 910 is configured to detect and control the synchronization with the movie and to perform decision processes in order to determine how to modify the soundtrack to generate the personalized soundtrack. The choice of the stream (also referred to as “stream choice”) generated by the decision-making routine 910 and the dynamic features determined by the decision-making routine 910 are then transmitted to a personalized soundtrack generation routine 920. The personalized soundtrack generation routine 920 of the digital audio workstation (sequencer) uses data of the soundtrack database 300 (which may belong to the centralized server 900) to generate the personalized soundtrack 250.

FIG. 10 schematically illustrates the execution of the decision-making routine 910 as a function of time, in accordance with at least one embodiment of the present disclosure. Several switching sound gates 1010 are implemented. At each switching sound gate 1010, the re-adjustment of the soundtrack (in other terms, generation of a new soundtrack) may be performed based on explore or exploit decision described above with reference to FIG. 7. For this, prior to the switching sound gate 1010, the system measures and obtains biosensor data from various devices (camera 170, EEG sensor 210, etc.) to determine the user's state. Stream is determined and dynamic features are adjusted at the switching sound gate 1010. The user 160 receives the adjusted user-specific soundtrack (also referred to herein as “personalized soundtrack”) through the headphone device 200. The user's state is measured during this reference time period, also referred to as a “reading window 1020” in FIG. 10. The reading window 1020 represents the reference time for which the data is being measured and transmitted to the processor 130 in order to be used for the decision related to a specific gate 1010.

FIG. 11 illustrates the execution of the personalized soundtrack generation routine 920, in accordance with at least one embodiment. FIG. 11 shows the variations in sound characteristics as a function of fluctuations in bio-signals (of the biometric data) gathered (collected from) of the viewer 160 (participant).

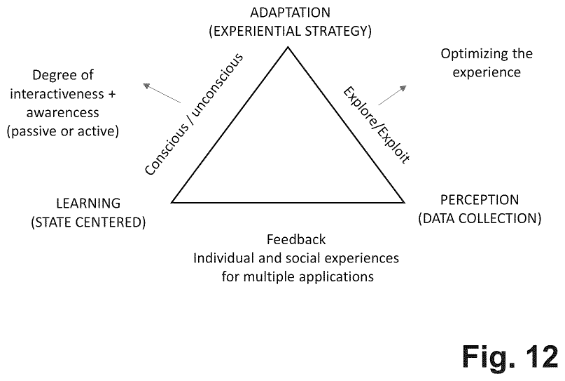

FIG. 12 schematically illustrates that the execution of the method, in accordance with at least one embodiment, comprises using optimization routine of Explore/Exploit as discussed with reference to FIG. 7, determining the degree of adaptiveness and awareness (both passive and active of the user 160), and generating the feedback to the user.

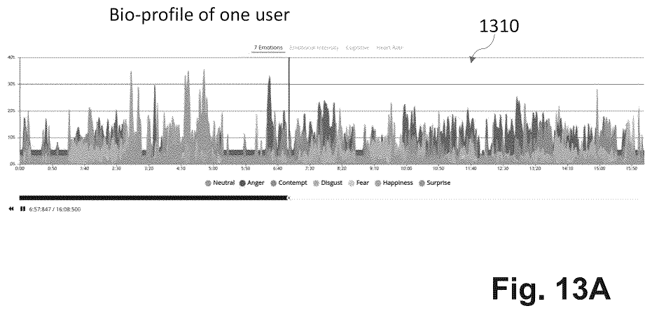

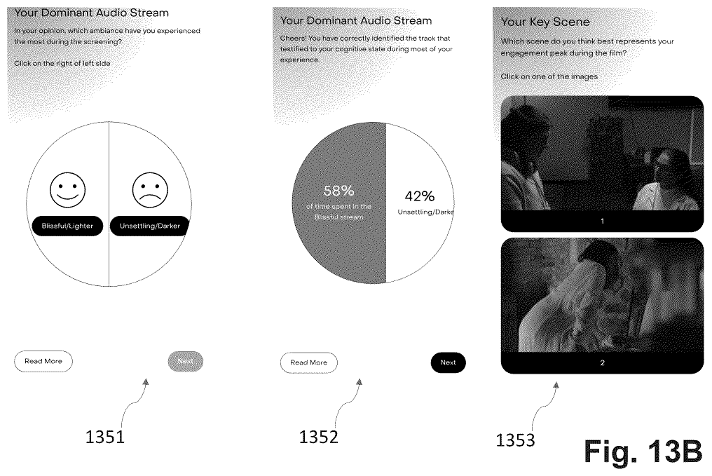

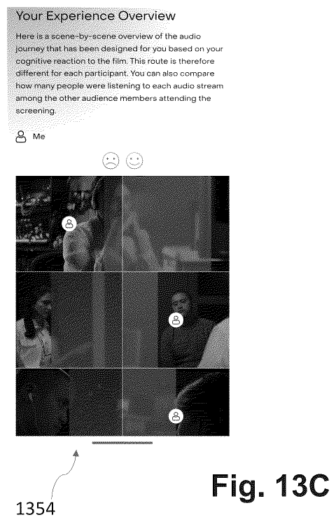

FIG. 13A illustrates a non-limiting example of visualization of the bio-signals (which may referred to as a “bio-profile”) of one user 160, which may be generated, for example, using visualization technology of RE-AK Technologies. The bio-signals 1310 of each user 160 may be obtained based on the EEG, PPG and an infrared camera recording which, combined, provide data on various emotions (neutral, anger, contempt, disgust, fear, happiness, surprise) and cognitive states of the users. In this example, the video data (recording) acquired via the infrared camera 170 provides information on various emotions (neutral, anger, contempt, disgust, fear, happiness, surprise) of the user 170. Additionally, cognitive indices and physiological arousal are measured via EEG and PPG respectively, and may be displayed to the user 170 (or, for example, an operator of the system 100) on separate tabs on the screen of the user device 180. Video data of the user 170 during the audio-video experience may be also displayed on the user device 180.

In at least one preferred embodiment, the system 100 analyses the bio-signals and displays them to the user 170 as provided in or similar to FIGS. 13B and 13C. In at least one embodiment, the system 100 may determine which ambiance the user has experienced the most during the screening. For example, the application executed on the user device may question the user (in a form of a quiz) after the presentation which ambiance the user thinks that they experienced the most during the screening. For example, the user 100 may be invited to choose between “blissful/lighter” and “unsettling/darker” (see FIG. 13B, screenshot 1351). The quiz question may be, for example: In your opinion, which ambiance have you experienced the most during the screening? Click on the right or left side.” The system 100 may determine the ratio of one or another ambiance (or state) based on various emotions and cognitive states determined as described herein. The system may also determine how much time did the user 170 spent in the one or another state (blissful stream or unsettling/darker stream, for example). The system 100 may display the ratio of time (as illustrated in FIG. 13B, screenshot 1352) or the amount of time spent by the user 170 in one or another stream or state.

The system 100 may also determine which scene the best represents the peak of the user's engagement during the peak. For example, two scenes may be presented to the user 170 to select one scene that the user thinks was the most engaging (screenshot 1353, FIG. 13B). The system 100 may then display to the user the scene that the system 100 has determined to be the most engaging and may display to the user 170 that scene.

In at least one embodiment, the system 100 may present to the user 170 a scene-by-scene overview of the audio journey that has been designed specifically for the user 170 based on their cognitive reaction to the film, as illustrated in FIG. 13C, screenshot 1354. In at least one embodiment, the system 100 may determine how many people were listening to each customized soundtrack (in other words, personalized soundtrack which may be referred to also as an “audio stream” as in FIG. 13C) among the other audience members attending the screening. For example, the various customized soundtracks may be presented (clickable pictures may be displayed, for example), and in some embodiments, along with the video data showing the user 170 and/or corresponding portions of the film, and, in some embodiments, data with respect to other audience members. In some embodiments, in addition, the picture, link to, or an indication of cognitive reaction of the user 170 (and the indication of the user's state) may be displayed simultaneously.

In some embodiments, prior to performing the audio-video experience, the system 100 may request the user to properly install the headphone device 200 and the biometric sensor 210 (biometric sensor device 210). For example, the system 100 may present illustrations with proper and wrong installation of the devices on the user's head and how to adjust the position of the devices.

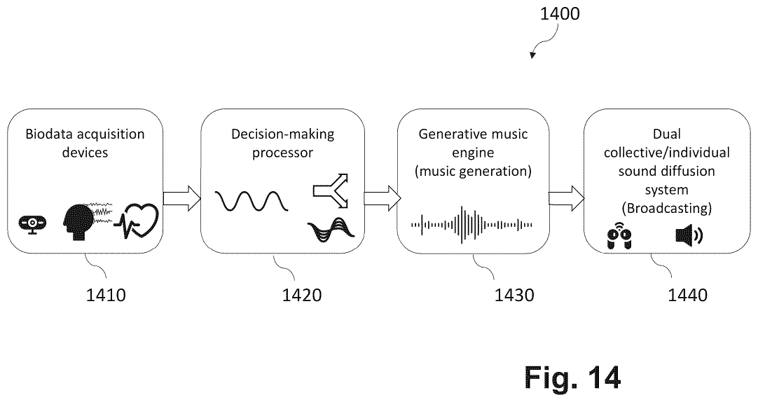

FIG. 14 illustrates a continuous real-time data processing pipeline 1400, which is a portion of the system 100, in accordance with at least one embodiment. The continuous real-time data processing pipeline 1400 comprises the acquisition devices 1410 such as EEG sensors 210, the decision-making processor 1420, the generative music engine 1430 that generates the personalized soundtrack 250, and the dual collective/individual sound diffusion system 1440 that broadcasts the personalized soundtrack 250. These four elements are designed to process data continuously across the experience and form the basis of the bio-feedback adaptive movie theater system.

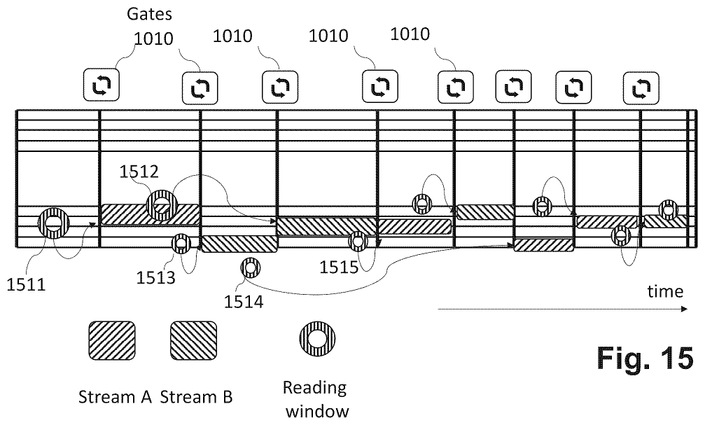

FIG. 15 illustrates a timeline of the adaptive soundtrack, in accordance with at least one embodiment. For example, the initial soundtrack that has been prepared by the producer of the audio-video experience may comprise two steams: sound stream A and sound stream B. At each gate 1010, a decision on whether to provide to the user 160 the sound stream A or B is taken by analyzing the set of data (biodata) representing, for example, the brain signals produced during the associated reading window 1511, 1512, 1513, 1514, 1515. For example, based on the first reading window 1511, the processor may determine, at the switching sound gate 1010, that stream A needs to be presented to the user 160. However, based on the analysis of the second set of biodata recorded during the second reading window 1512, the processor may determine that the second stream B needs to be presented to the user, for example, during a fourth time period, where the fourth time period follows the third time period. For example, during one time period during which one soundtrack is played to the user, biodata may be collected during two different (in time and/or in length) reading windows which may influence two different subsequent time periods. In some embodiments, collection of biodata during one reading window 1514 of one time period may influence the decision regarding which stream A or B to perform to the user 160 much later in the audio-video experience, following several other sound streams after the earlier reading window 1514.

Playing synchronously of the audio and video means that the dialogue in the movie corresponds to the sound emitted both by the headphones and the room sound. For each soundtrack between the switching sound gate 1010, the execution (playing) of multiple soundtracks needs to be synchronous. Therefore, the data is collected during a reference time period, then the soundtrack is adjusted (a new soundtrack is generated) at the switching sound gate, and then performed during a first time period. While the soundtrack is played during the first time period, measurements, using the sensors and cameras 170, are performed. Thus, the first time period may become later a second reference time period for the future adjustments at the next switching sound gate. The second reference time period may be shorter than the first time period, providing a time buffer in order to collect and analyze data before generating a new soundtrack and transmitting it to the headphones.

A method for providing an audio-video experience to a plurality of users, the method executed by a processor coupled to a soundtrack database, a camera, biometric sensors, a room speaker and a headphone device, the method comprising: performing a base soundtrack for the audio-video experience for a reference time period; collecting data from the biometric sensor and the camera for each user of the plurality of users during the reference time period to determine biometric data and facial analysis data and head motion data; determining a first state of each user based on the biometric data; in response to determining that the user needs to be pushed to a second state: based on a base soundtrack for the audio-video experience for a first time period, biometric data in the first state, and facial analysis data and head motion data during the reference time period, generating a personalized soundtrack, generating a room sound based on the base soundtrack; synchronizing the personalized soundtrack with the room sound and video of the audio-video experience; simultaneously and synchronously playing the personalized soundtrack on the headphone device, the room sound on the room speakers and video on a screen during the first period of time. The audio-video experience may be a movie. The biometric data may comprise heartbeat (PPG), EDA, and brain activity (EEG) measured by the biometric sensors.

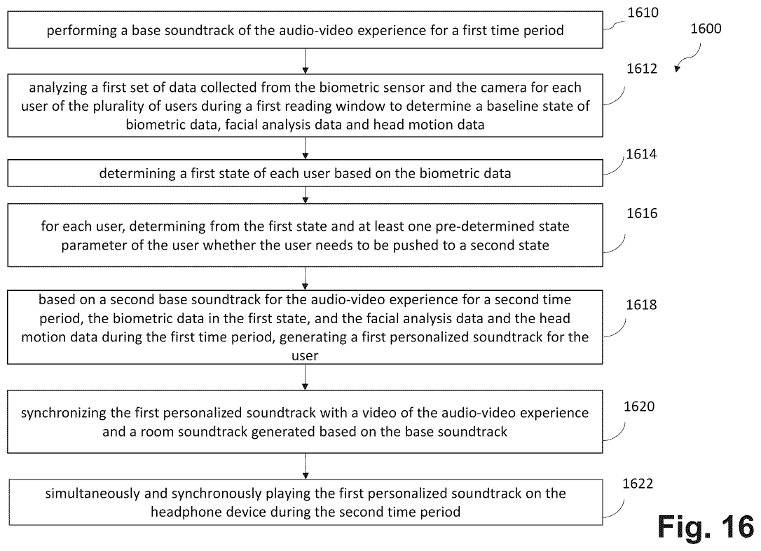

Referring now to FIG. 16, where the method 1600 for providing an audio-video experience to a plurality of users is illustrated in accordance with at least one embodiment of the present disclosure. At step 1610, a base soundtrack of the audio-video experience for a first time period is performed. At step 1612, a first set of data collected from the biometric sensor and the camera for each user of the plurality of users during a first reading window is analyzed to determine a baseline state of biometric data, facial analysis data and head motion data. At step 1614, a first state of each user based on the biometric data is determined. At step 1616, for each user, the system determines from the first state and at least one pre-determined state parameter of the user that the user needs to be pushed to a second state. If the user needs to be pushed to the second state, based on a second base soundtrack for the audio-video experience for a second time period, the biometric data in the first state, and the facial analysis data and the head motion data during the first time period, a first personalized soundtrack for the user is generated at step 1618. The first personalized soundtrack with a video of the audio-video experience and a room soundtrack, generated based on the base soundtrack, is synchronized at step 1620. At step 1622, the first personalized soundtrack on the headphone device during the second time period, the first room soundtrack on the room speakers and the video on a screen during the second time period are played simultaneously and synchronously.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for providing an audio-video experience to a plurality of users, the method executed by a processor coupled to a soundtrack database, a room speaker, and, for each user, a camera, a headphone device and a biometric sensor, the method comprising:
performing a base soundtrack of the audio-video experience for a first time period;
analyzing a first set of data collected from the biometric sensor and the camera for each user of the plurality of users during a first reading window to determine a baseline state of biometric data, facial analysis data and head motion data;
determining a first state of each user based on the biometric data;
for each user, in response to determining from the first state and at least one pre-determined state parameter of the user that the user needs to be pushed to a second state:
based on a second base soundtrack for the audio-video experience for a second time period, the biometric data in the first state, and the facial analysis data and the head motion data during the first time period, generating a first personalized soundtrack for the user,
synchronizing the first personalized soundtrack with a video of the audio-video experience and a room soundtrack generated based on the base soundtrack; and
simultaneously and synchronously playing the first personalized soundtrack on the headphone device during the second time period, the first room soundtrack on the room speakers and the video on a screen during the second time period.

2. The method of claim 1, wherein determining the first state of the user is performed periodically at a pre-determined time interval during the audio-video experience.

3. The method of claim 1, further comprising adjusting the first room soundtrack based on a plurality of personalized soundtracks comprising, for each user, the first personalized soundtrack.

4. The method of claim 1, further comprising, at the end of the first period of time:
analyzing data collected from the biometric sensor and the camera for each user of the plurality of users during the second period of time to determine the baseline state of biometric data, facial analysis data and head motion data;
determining a third state of each user based on the biometric data, the third state having been achieved during second period of time;
for each user, in response to determining from the third state and at least one pre-determined state parameter of the user that the user needs to be pushed to a fourth state:
based on a second base soundtrack for the audio-video experience for a second time period, biometric data in the first state, and facial analysis data and head motion data during the second time period, generating a second personalized soundtrack for the user, and
synchronizing the second personalized soundtrack with and the video of the audio-video experience and the room soundtrack; and
simultaneously and synchronously playing the second personalized soundtrack on the headphone device during a third time period.

5. The method of claim 1, wherein the audio-video experience is a movie.

6. The method of claim 1, wherein the biometric data comprises a heartbeat obtained from a photoplethysmogram (PPG), electrodermal activity (EDA) and brain activity obtained from an electroencephalogram (EEG), the biometric sensor being an EEG sensor, a PPG sensor and an EDA sensor and the camera.

7. The method of claim 1, wherein the camera performs video and infrared recording, measuring facial expressions of the respective user.

8. The method of claim 1, wherein the first time period and the second time period have another time period in between them.

9. The method of claim 1, further comprising using cognitive and emotional analysis.

10. The method of claim 9, wherein the cognitive and emotional analysis comprises analyzing a degree of interactiveness and awareness of the user.

11. The method of claim 1, further comprising analyzing the first state of the user to choose the base soundtrack for the audio-video experience and to determine dynamic features for use to generate the first personalized soundtrack.

12. The method of claim 1, further comprising generating, for each user, an individual visual representation of the user's reaction to the audio-video experience and transmitting it to a user device.

13. A system for providing an audio-video experience to a plurality of users, the system comprising:
a soundtrack database comprising a set of base soundtracks and a set of videos for the audio-video experience;
a room speaker and a room screen for providing the set of videos, and,
for each user, a camera and a headphone device, each headphone device having a biometric sensor configured to play a base soundtracks of the audio-video experience for a first time period and a personalized soundtrack for a second time period; and
a processor coupled to a soundtrack database, the processor configured to:
force the headphone device of each user to play a base soundtrack of the audio-video experience for a first time period;
receive from the biometric sensor and the camera a first set of data for each user of the plurality of users during a first reading window and analyze, for the plurality of users, a plurality of the first set of biometric data, facial analysis data and head motion data to determine a baseline state of each user;
based on the first set of biometric data, determine a first state of each user;
for each user, in response to determining from the first state and at least one pre-determined state parameter of the user that the user needs to be pushed to a second state:
based on a second base soundtrack for the audio-video experience for a second time period, the biometric data in the first state, and the facial analysis data and the head motion data during the first time period, generate a first personalized soundtrack for the user,
synchronize the first personalized soundtrack with a video of the audio-video experience and a room soundtrack generated based on the base soundtrack; and
force the headphone device of each user to simultaneously and synchronously play the first personalized soundtrack during the second time period,
force room speakers play the first room soundtrack and visualize the video on a screen during the second period time period.

14. The system of claim 13, wherein the biometric sensor is at least one of an EEG sensor, a PPG sensor and an EDA sensor.

15. The system of claim 13, wherein the camera performs video and infrared recording, measuring facial expressions of the user.

16. The system of claim 13, wherein the processor is further configured to analyze the first state of the user to choose the base soundtrack for the audio-video experience and to determine dynamic features for use to generate the first personalized soundtrack.

17. The system of claim 13, wherein the processor is further configured to, for each user, generate an individual visual representation of the user's reaction to the audio-video experience and transmit it to a user device for displaying on a screen of the user device.
